(19) United States
(12) Patent Application Publication
(10) Pub. No.: US 2026/0169502 A1
(43) Pub. Date: Jun. 18, 2026

(54) Remote Robot-Assisted Control of an Electronic Device

(71) Applicant: Samsung Electronics Co., Ltd., Suwon-si (KR)

(72) Inventors: Heinz Pabst, New York, NY (US); Andres Leonardo de Jesus Ortega Pena, San Jose, CA (US); Ashwin Chandra, Santa Clara, CA (US); David Ho Suk Chung, Rancho Palos Verdes, CA (US)

(21) Appl. No.: 19/232,029

(22) Filed: Jun. 9, 2025

Related U.S. Application Data
(60) Provisional application No. 63/735,628, filed on Dec. 18, 2024.

(51) Int. Cl. G05D 1/689; G05D 107/40

(52) U.S. Cl. CPC G05D 1/689; G05D 2107/40

(57) ABSTRACT

In one embodiment, a method includes receiving, at an autonomous mobile robot, a request for the robot to remotely control a function of an electronic device comprising a display screen; and determining, by the autonomous mobile robot and based on one or more images of the display screen captured by a camera of the robot, whether a current location of the robot is an optimal location to remotely control the function of the electronic device. The method then includes one or more of: in response to a determination that the robot's location is not an optimal location, then adjusting, by the autonomous mobile robot, a position of the robot; and in response to a determination that the robot's location is an optimal location, then processing the request.

### PRIORITY CLAIM

This application claims the benefit under 35 U.S.C. § 119 of U.S. Provisional Patent Application No. 63/735,628 filed Dec. 18, 2024, which is incorporated by reference herein.

### TECHNICAL FIELD

This application generally relates to remote robot-assisted control of an electronic device.

### BACKGROUND

Many electronic devices are capable of being controlled remotely. For instance, rather than providing input to the electronic device or controlling functions of an electronic device using an interface (e.g., touchscreen, buttons, etc.) built into the device itself, or via a wired connection to the electronic device, many electronic devices can receive wireless communications that control the functionality of the device.

Wireless remote-control technologies include infrared (IR) and radio-frequency (RF) communication technologies, as well as Bluetooth and Wi-Fi communications, among other techniques. For example, certain functions of a television can be controlled remotely through the use of a wireless remote control. For instance, a remote control may have an interface such as buttons, sliders, touch-sensitive areas, etc., and a user may use these interfaces to provide input to the remote, which outputs corresponding signals to the TV. For example, a user may navigate among selectable objects displayed on a graphical user interface (UI) of the TV's display screen, may select a particular UI object, and may adjust device functions such as powering on or off the TV or adjusting a volume of the TV or of an output device (e.g., a set of speakers) connected to the TV, etc.

### BRIEF DESCRIPTION OF THE DRAWINGS

FIG. 1 illustrates an example method for performing remote control of an electronic device by an autonomous mobile robot.

FIG. 2 illustrates an example of environment of an autonomous mobile robot.

FIG. 3 illustrates an example autonomous mobile robot that uses a multi-modal task delegation (MTD) model to fulfill a user request.

FIG. 4 illustrates an example of an action model used by an embodiment of an autonomous mobile robot.

FIG. 5 illustrates an example computing system.

### DESCRIPTION OF EXAMPLE EMBODIMENTS

Remotely controlling an electronic device, for example controlling a TV using a remote control, can be frustrating due to the steep learning curve for determining which remote-control interfaces (e.g., buttons) correspond to which specific functions. In addition, performing a task such as navigating from a TV home screen to a particular content item in a particular application requires a user to understand the navigation structure of the TV's UI and the particular application's UI, which likewise can be annoying to learn, difficult to remember, and exhausting to repetitively perform.

In contrast, the disclosure describes an autonomous mobile robot capable of remotely controlling an electronic device based on a user request (e.g., a voice command from a user). As explained below, the robot includes a camera for capturing images of a display of the electronic device in order to control a functionality of the electronic device and fulfill the user request. The robot can eliminate manual device-UI navigation and reduces the user's learning curve regarding interaction interfaces for the electronic device. Moreover, the robot can provide additional methods of control (e.g., voice control) that are not natively supplied by the electronic device, and the robot can synthesize these input controls to work across multiple electronic devices and applications (e.g., across many different brands of televisions, each of which may otherwise respond only to device-specific input commands). In addition, the techniques described herein can completely eliminate the need for a user-operated remote control of an electronic device, while still providing the full suite of functionality obtainable via remote control.

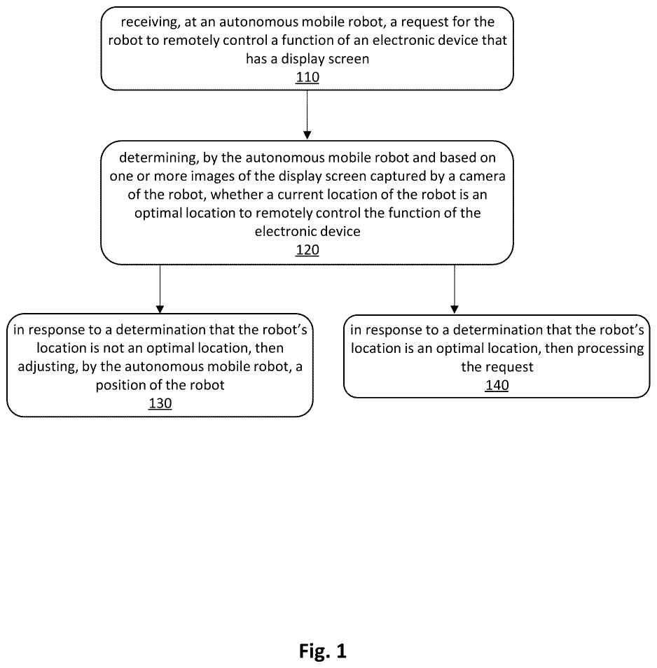

FIG. 1 illustrates an example method for performing remote control of an electronic device by an autonomous robot. Step 110 of the example method of FIG. 1 includes receiving, at an autonomous mobile robot, a request for the robot to remotely control a function of an electronic device that includes a display screen. The autonomous mobile robot (or “robot” as used herein) is capable of autonomously moving around its environment, as described more fully below. The electronic device may be a television, and several examples in this disclosure describe embodiments in which the electronic device is a television. However, this disclose contemplates that the electronic device may be any electronic device that has a display screen and that has at least some functionality that can be wirelessly controlled.

The request in step 110 may be communicated directly by a user to the robot, in particular embodiments. For example, a user may input the request using voice activation (e.g., by speaking the request to the robot), features, through an on-robot control interface or a remote-control device, etc. The request may also be communicated to the robot via one or more connected intermediary devices. For instance, the user may submit a request using, e.g., a smartphone (e.g., by interacting with an application on the smartphone, by using voice controls on the smartphone, etc.), and the smartphone may communicate the request to the robot. Similarly, the user may submit a request using a voice assistant of a separate electronic device, which may submit the request to the robot.

In particular embodiments, the user request is represented as an intent that identifies the requested function, or goal, that the user would like the electronic device to perform. For instance, a connected device may receive a user request and then process the request by identifying an intent (among other things, in particular embodiments) and then communicate that intent to the robot. In other embodiments, the user request is processed by the robot, for example by the robot identifying an intent from the user request. In particular embodiments, the intent may be a textual representation of the user request (e.g., using voice-to-text transcription techniques). This textual representation may be an exact transcription, or may represent the semantic meaning of the user request without necessarily being an exact transcription (e.g., may be a summary of the user request generated by, for example, an AI model on the robot or a connected device).

In particular embodiments, the user request may be decomposed into specific actions for the robot to take to cause the electronic device to perform specific functions that will fulfill the user's request. For instance, if a user request is “play Movie1 on App1 on the TV,” then this request may be decomposed into the following actions: (1) launch App1 (2) select the default user profile (3) search for the requested movie, Movie1 (4) select the movie and (5) find and select the play button on TV screen to initiated playback. The specific actions that a request is decomposed into may depend on the specific application or electronic device (or both) that the request pertains to, as explained more fully below. In addition, as explained below, the specific steps (e.g., how to navigate the user interface) the robot must take to implement these actions in a particular application and on the particular TV is determined by the robot in order to perform the specific actions.

While the example request above pertains to playing a specific content item on a particular application, a user request may pertain to any functionality of the target electronic device that can be remotely controlled. For instance, if the electronic device is a TV, then a request may be to access a specific user profile on a particular application or to adjust a setting on the TV, an application, or a connected device (e.g., a digital media player); for example, a request to adjust the brightness of the TV's screen or to adjust the volume of corresponding audio.

Step 120 of the example method of FIG. 1 includes determining, by the autonomous mobile robot, whether a current location of the robot is an optimal location to remotely control the function of the electronic device. This determination is based on one or more images of the display screen captured by a camera of the robot. The camera may be one or more cameras, and may use any suitable sensing technology (e.g., may be an optical (e.g., RGB) camera, an IR camera, a depth camera, or any combination of these, etc.).

In step 120 of the example method of FIG. 1, the robot captures a view of the display screen in one or more images and, based on the captured view, determines whether the robot is in an optimal location to remotely control the functionality of the device. There may be more than one optimal location, as explained below.

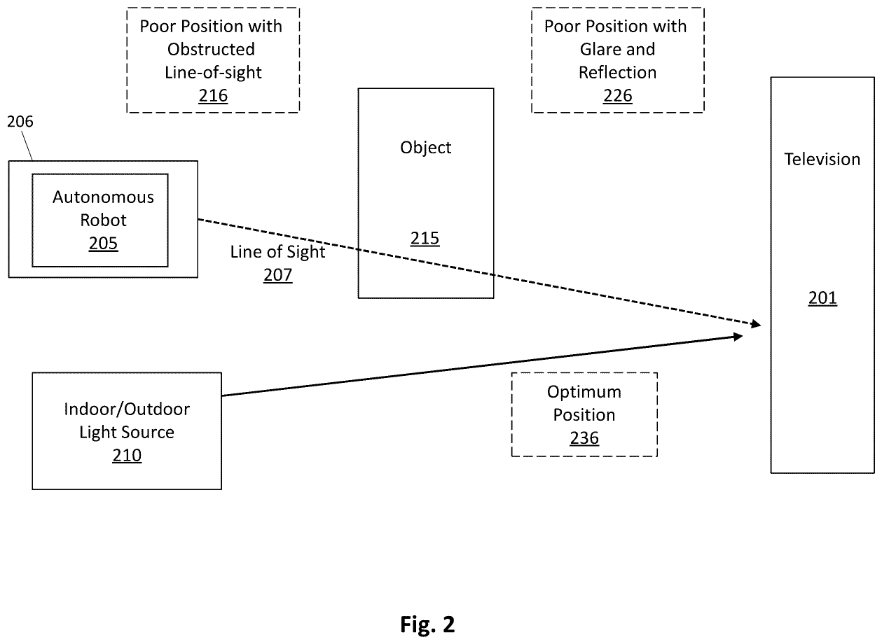

In particular embodiments, whether the robot is in an optimal location for controlling the functionality the electronic device depends on visual parameters associated with the robot's image(s) of the display screen. For instance, visual parameters can include one or more of (1) reflections from the display screen (e.g., glare) (2) blurriness or sharpness of the display screen (3) the robot's viewing angle of the display screen and (4) any occlusion or blockage of the view of the display screen. FIG. 2 illustrates an example of step 120 in an example environment of robot 205. At robot 205's current location 206, a camera of robot 205 pointing toward TV 201 has a line of sight 207. In the example of FIG. 2, line of sight 207 to TV 201 at location 206 is obstructed by an object 215, making location 206 not an optimal location for robot 205. An example light source 210 is shown in the example of FIG. 2, which light sources (whether artificial (e.g., a lamp) or natural (e.g., daylight coming through a window)) create visual artifacts (e.g., glare and reflections) at location 226. At location 216, the view of TV 201 is also obstructed by object 215. Thus, locations 206, 216, and 226 are not optimal locations, while in the example of FIG. 2, location 236 is an optimal location for robot 205 to remotely control the functionality of TV 201, in part by viewing the display screen of TV 201.

In particular embodiments, an optimal location may be determined by converting the values of the visual parameters at a particular location to an overall image-quality score, and if this score does not meet a threshold, then the particular location is not an optimal location. In particular embodiments, an optimal location can be determined using computer vision techniques, e.g., to determine the clarity of, or artifacts in, one or more images of the robot's view of the electronic device. In particular embodiments, an optimal location can be determined by a trained AI model, such as a vision-language model (VLM) described below, trained to output device-screen image quality classifications or metrics from one or more input images of that screen.

In particular embodiments, a robot may identify multiple potential locations for controlling an electronic device and then may sequentially navigate to these locations and determine the image quality at each one. The robot may continue this navigation even if one of the potential locations is determined to meet the criteria of an optimal location, e.g., has an image quality score higher than a threshold score. The robot may then select the highest scoring location that meets the optimal-location criteria as the location from which to control the electronic device. In particular embodiments, a robot may stay at the first potential location determined to meet the optimal location criteria, even if other unvisited, identified potential locations exist.

In particular embodiments, a robot may process one or more images of the electronic device in order to determine whether the robot is at an optimal location. This processing may match any image processing that occurs during control of the electronic device, as explained more fully below, for example so that the optimal-location evaluation is working on the same image data as is the functionality control. For example, when evaluating whether the robot is at an optimal location, the robot may crop each image of the electronic device to the device's display screen (e.g., by detecting corners of the display screen), de-skew this image (if necessary), and reproject the image to a head-on viewing angle relative to the TV screen. This processed image may then be used to evaluate image quality to determine whether the robot is at an optimal location to remotely control a functionality of the electronic device.

Step 130 of the example method of FIG. 1 includes in response to a determination that the robot's location is not an optimal location, then adjusting, by the autonomous mobile robot, a position of the robot. For instance, the robot may include an autonomous indoor navigation (AIN) module, which in the field of robotics performs mapping, localization, navigation, and inventorying of objects in the robot's environment, including each object's 3D coordinates. These objects and the map of the robot's location relative to these objects is used to perform repositioning of the robot.

In particular embodiments, a robot may perform a 360-degree image scan of its environment, for instance by panning a camera or by using a set of cameras that cover this 360-degree field of view. Other embodiments may use a smaller field of view for image scanning. Using the scanned image or images that result, the robot can then identify whether the object of interest (i.e., the electronic device to control) is visible, and can also perform the environmental mapping and object detection described above. Based on the robot's and the target device's identified locations, then a number (e.g., four) of candidate optimal locations can be determined about the target object, e.g., precomputed every 45° around the target, aggregating a 180° compound field of view from the target's perspective. The robot may then reposition (navigate to) a candidate location, such as the nearest candidate location or a predicted highest-scoring location. Once there, the robot positions its camera toward the target device, e.g., by rotating the camera or by positioning the robot so that the camera is facing the target device. If more than one camera is used to capture images of the device display in order to remotely control functionality of the device, then each of these cameras may be positioned toward the display of the electronic device.

Continuing the example above, the image quality at the robot's location is evaluated. As described above, the robot may stay at the location if it qualifies as an optimal location or may continue moving to and scoring other candidate locations. Once an optimal location is selected (which may require identifying and exploring a new set of potential optimal locations, in particular embodiments), then the robot can begin controlling a functionality of the electronic device.

Step 140 of the example method of FIG. 1 includes in response to a determination that the robot's location is at the optimal location, then processing the user's request. In other words, the robot performs one or more actions (e.g., navigating through UI menus of an application and selecting a particular movie to play on the TV) that correspond to the functionality sought by the user's request.

For example, a camera (or more than one camera) of the robot captures an image of the display screen of the electronic device. This image could be updated at the camera's refresh rate, or at another interval. The camera here may be the same camera or set of cameras used for mapping and navigation, or may be a different camera or set of cameras.

To perform the request functionality, particular embodiments use a trained vision language model (VLM) to analyze the current content displayed on the device screen (as captured by the current image of the robot's camera). In particular embodiments, the robot breaks the task into two stages (1) a planning stage that determines a sequence of user interfaces to go from the current display to the goal state and (2) within each displayed user interface, the action or sequence of actions that must be performed to move to the next user interface or to implement the requested function. In particular embodiments, these two stages may be performed be separate components (e.g., using a multimodal approach), while in other embodiments these two stages may be performed by a single component (e.g., a single trained VLM).

For instance, one multi-modal approach uses a trained task-planner, such as an LLM (e.g., a VLM) that takes as input (1) the user's request (whether processed or as a literal transcription) and (2) the current image captured by the robot to output a sequence of navigations through particular user interface, or UI states, of the electronic device. These interfaces may be application specific and/or device specific, as described below. Thus, the task planner may learn the hierarchical navigation among different UI screens, and at inference time the task planner formulates a plan/state of completion across multiple user interfaces (UI states) of the electronic device.

In particular embodiments, once the trained task planner outputs the disclosed state-of-completion sequence, then a trained VLM determines, for each UI captured by the robot's camera, the specific operations that may be required to accomplish the state of completion. For instance, suppose a user requests to play a specific movie on a particular application on a TV. A state of completion plan may be to (1) turn on the TV (2) launch the application (3) navigate to a search interface (4) search for the movie and (5) play the movie. Each of these steps may be associated with a particular user interface, which may be arranged in a hierarchical, graph-like structure. To accomplish this state of completion, each step may require a specific sequence of inputs to the TV. For instance, upon launching the application, the TV may display a home screen of the application, which is captured by the robot's camera. To move to the next state in the sequence, the robot may need to perform specific operations (e.g., navigate up, up, up, left, then select), to move a displayed selection element on the interface from its current position to the icon that launches the application's search interface. This specific sequence of operations may be determined by the robot's trained VLM, and is based on the current image of the TV's display screen captured by the robot camera. Thus, in this multimodal example, the VLM determines which specific input operations may need to be performed in order to perform each step of the state-of-completion plan.

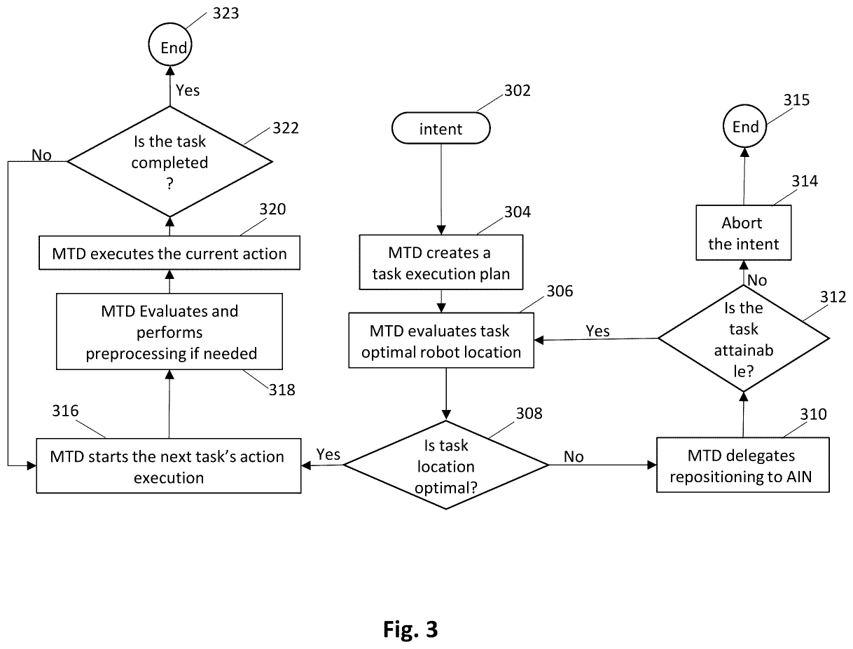

FIG. 3 illustrates an example embodiment in which a robot uses a multi-modal task delegation (MTD) system to break down a user's request into three types of actions: repositioning (modifying the robot's physical conditions), state flow (tracking task state, managing delays, and evaluating action preconditions and completion), and device control, e.g., via smart home automation or IR remote control. For instance, in the example of FIG. 3, a user intent 302 is used to creates a task execution plan in 304. Given this task execution plan, the MTD of the robot evaluates in step 306 whether the robot is currently at an optimal location for the task. At decision block 308, if the robot is not at an optimal location, then in the example of FIG. 3, the MTD delegates reposition of the robot to an AIN module at 310. The AIN module determines in step 312 whether the task is attainable, e.g., whether the robot can move to a position which is an optimal location for executing the task. If not, then the task may end at step 315. If yes, then the MTD again determines whether the robot is in an optimal location at 306. This process repeats until the result of decision block 308 is yes, at which point in the MTD in the example of FIG. 3 starts that task's action execution at 316.

The MTD performs evaluation and any preprocessing, in particular embodiments, at step 318 for the current action that may be needed to perform the execution plan. The MTD executes the action at 320, at which point the MTD determines at decision block 322 whether the overall task is complete. If not, then the MTD returns to 316 to perform the next action in the task execution plan. For example, as explained above, a set of actions for a user intent of “play movie1 on app1 on the TV” may be decomposed into a specific set of actions, such as “launch app1” and “select default user profile” for completing the task. If the overall task is completed, then the example approach of FIG. 3 ends at step 323.

In particular embodiments, the task planner and the VLM may be trained on device specific and/or application-specific training data. For instance, training data may include inputs that include the user's intent and, e.g., a navigation structure for the particular application, and the desired output is the particular instruction sequence (e.g., remote keypress sequence) that may be needed to achieve the user's goal.

In particular embodiments, a task planner may be trained by providing the untrained task planner with a navigation structure for a particular device or application. The navigation structure may be represented as a graph-like or tree-like structure. For instance, the navigation structure may represent that the root node for appX is profile selection; below this node is a node for selecting a specific profile and a node to add another profile, and below each of these nodes are respective landing-page nodes (e.g., beneath the node for selecting a specific profile may be a node representing appX's home screen.). Edges or connections between nodes can be used to represent the available paths one can take from a particular node to another node in the graph.

The navigation structure used during training can be provided in graphical form, textual form, or a combination thereof. From the corpus of training data, the task planner is trained to associate particular display screens with particular nodes of the navigation structure and learns how to navigate the particular navigation structure to achieve a target goal.

The model that performs specific, within-UI actions (which may be the same model as the task planner or may be a different model, such as a different VLM) is trained based on training data such as input images of a particular user interface and a goal (e.g., an action to be performed), and the output is a predicted sequence of remote-control operations on the UI to perform the action. For example, the output may be a sequence of “keystrokes” (e.g., up, up, left, left, up) to navigate from a currently selected UI element to an element that completes the action within the particular UI state output by the task planner.

In particular embodiments, during training optimal prompt templates may be created and enhanced to address parsing requirements for various use-case scenarios. These enhanced templates distinguish what types of instructions will optimize the LLM's parsing of the input based on user intent and the input image and what additional information should be included. Inference may then include selecting a prompt template by processing the user input and image, e.g., through a Visual Tower (e.g., CLIP) and a specialized classifier head, which selects the appropriate prompt to provide to the VLM. This classifier may also determine whether the input image is actionable and/or if a language model should be activated. If the image is actional, then the task planner may generate a JSON representation of the parsed image as dictated by the selected augmented prompt template, which includes details about elements, relationships, and other pertinent data.

For instance, a robot may include a VLM that includes a large language model, an image encoder (a Visual Tower), and a projection layer that permits combining visual and text tokens using a specified prompt template. For the UI screen understanding, particular embodiments of the VLM decompose a task into document layout parsing, OCR recognition, and action planning and execution based on the target electronic device APIs or remote commands (e.g., IR commands) that are available to it.

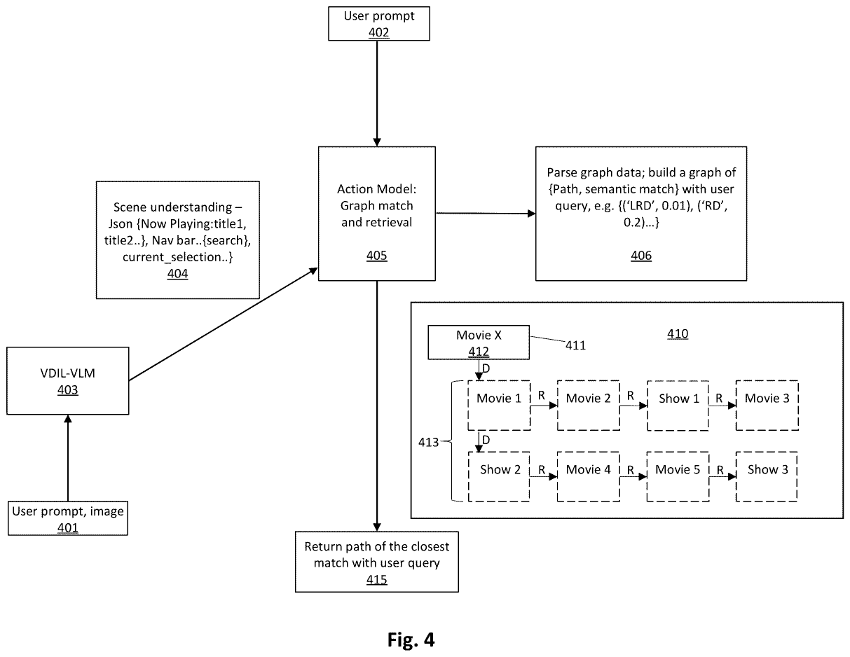

In particular embodiments, an action planner can utilize a graph representing objects or UI elements and their spatial relationships in an input image. FIG. 4 represents an example embodiment of an action model during inference time. As illustrated in FIG. 4, the action model may take as input 401 a user input and one or more images captured by one or more cameras of the robot. Input 401 is provided to a VLM 403, which in particular embodiments outputs a scene understanding 404 of the input image. Action model 405 may then parse the graph data in step 406 to build a graph of potential paths and corresponding potential semantic matches to the user query's goal. For instance, as illustrated in FIG. 4 the sequence “left-right-down” (LRD) in the input image may have a semantic match of 0.01, and so forth. The input image itself is represented as graph structure 410, which may be determined by action model 405. For instance, in graph structure 410 for the input image in input 401, the current selection 411 is identified as movie X 412. Each content element 413 in the input image is represented as a node, and edges represent available movement directions to navigate to corresponding nodes (only one direction of navigation is shown, but this disclosure contemplates that other edges and directions may be included, e.g., an edge permitting moving down from Movie 3 to Show 3, or an edge to move left from Show 1 to Movie 2). Based on the parsed graph 406, action model 405 may then return the path (sequence of operations, e.g., “down-right-right-down”, etc.) that has the closest match (e.g., highest semantic score) to the user's query. Here, the user query may be the user's requested action or may be a particular action, e.g., an action of a task execution plan described above.

In particular embodiments, training data may be unskewed (head on) images of a display screen, and therefore one reason de-skeweing and reprojection during inference is useful is because the real, inference-time data may then match the form of the training data, resulting in improved inference results.

To perform the selected action sequence, the robot wirelessly communicates with the electronic device. For example, the robot may use IR, RF, Bluetooth, or Wi-Fi signaling, etc., to communicate with a TV and simulate particular output (e.g., button presses) of a remote control for that device. Mappings of physical output signals (e.g., specific IR signals) to device-specific functions are typically created programmatically for a particular electronic device.

While the examples above for remotely controlling the functionality of an electronic device primarily concern performing some requested function of that device, particular embodiment may also be used to provide tutorials to the user. For instance, a user could request “show me how to turn on closed captions in App2,” and the robot may then show the user how to perform the function by, as described above, determining the steps that may be necessary to turn on closed captions in App2. These steps can be shown on the screen, i.e., as the robot performs them, thereby showing the user exactly how to perform this functionality. In particular embodiments, the robot's determined approach for performing this functionality may also be provided to the user, e.g., as a textual description of the steps shown in a connected application on the user's computing devices (e.g., a smartphone).

Particular embodiments of the robot described herein may be used to control an electronic device that does not have a display screen, but does have functions that can be remotely controlled. For example, a portable heater or air conditioner may have an associated remote control, and a robot described herein may use the techniques described herein to receive a user request to control the device, determine and navigate to an optimal location for remotely controlling this device, and then implement the remote-based sequence of steps for performing the user's request at the optimal location. In particular embodiment, a VLM of the robot may be used to identify the device to be controlled.

In particular embodiments, a robot may not be mobile but rather may be stationary, yet may be used to remotely control an electronic device. For instance, a robot may not have the navigation capabilities described herein, but may nevertheless receive user requests and remote control the device to fulfill these user requests based on captured images of the device's display screen.

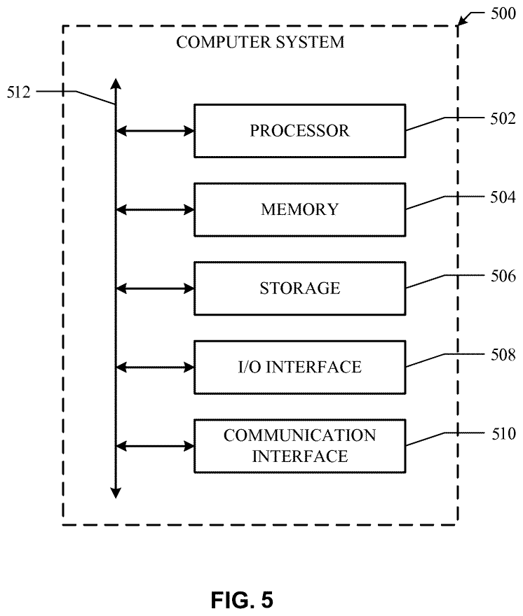

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates a system that includes one or more non-transitory computer readable storage media storing instructions; and one or more processors coupled to the one or more non-transitory computer readable storage media and operable to execute the instructions to perform certain functions includes embodiments in which those functions are performed by a single processor, embodiments in which those functions are performed by multiple processors that each perform all the functions, and embodiments in which those functions are performed by multiple processors (e.g., in separate computing devices) where each processor performs at least one function but less than all recited functions.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
receiving, at an autonomous mobile robot, a request for the robot to remotely control a function of an electronic device comprising a display screen;
determining, by the autonomous mobile robot and based on one or more images of the display screen captured by a camera of the robot, whether a current location of the robot comprises an optimal location to remotely control the function of the electronic device; and one or more of:
in response to a determination that the robot's location does not comprise the optimal location, then adjusting, by the autonomous mobile robot, a position of the robot; and
in response to a determination that the robot's location comprises the optimal location, then processing the request.

2. The method of claim 1, wherein the optimal location comprises a location at which the one or more images of the display screen meet one or more criteria for one or more visual parameters of a view of the display screen.

3. The method of claim 2, wherein the one or more visual parameters comprise one or more of (1) a reflection from the display screen (2) an occlusion of the display screen and (3) an angle at which the camera captures an image of the display screen.

4. The method of claim 1, wherein adjusting, by the autonomous mobile robot, a position of the robot comprises:
determining, by the autonomous mobile robot, a location of the robot relative to the display screen;
determining, by the autonomous mobile robot, one or more candidate optimal locations from which to remotely control the functionality of the electronic device; and
navigating, by the autonomous mobile robot, to at least one of the one or more candidate optimal locations.

5. The method of claim 1, wherein processing the request comprises:
capturing an image of content currently displayed on the display screen; and
determining, based on the user request and the captured image, a task execution plan for fulfilling the user request.

6. The method of claim 5, wherein determining the task execution plan comprises:
determining, by a VLM of the robot, a graph structure representing a set of display-screen UI states; and
determining a navigation of the graph structure from an initial state corresponding to the captured image to a final state corresponding to fulfilling the user request.

7. The method of claim 6, wherein each state in the graph corresponds to a particular user interface of the electronic device.

8. The method of claim 7, wherein each state in the graph corresponds to a particular user interface of an application executing on the electronic device.

9. The method of claim 6, further comprising, for each state in the navigation of the graph structure:
capturing an image of the display screen; and
determining, by a VLM of the robot, a particular sequence of remote operations to move from the current state to the next state in the navigation.

10. The method of claim 9, wherein determining the particular sequence of remote operations comprises:
determining, for each of a plurality of potential sequences of remote operations, a semantic match between the potential sequence and an input query; and
selecting the potential sequence of remote operations having the highest semantic match.

11. The method of claim 9, further comprising:
representing the image of the display screen as UI-based graph structure; and
determining the particular sequence of remote operations comprises determining a particular sequence of navigations traversing the UI-based graph structure.

12. The method of claim 1, wherein the electronic device comprises a television.

13. An autonomous mobile robot comprising:
a camera; and
one or more non-transitory computer readable storage media storing instructions, and one or more processors coupled to the one or more non-transitory computer readable storage media and operable to execute the instructions to:
receive a request for the robot to remotely control a function of an electronic device comprising a display screen;
determine based on one or more images of the display screen captured by the camera of the robot, whether a current location of the robot comprises an optimal location to remotely control the function of the electronic device;
in response to a determination that the robot's location does not comprise the optimal location, then adjust, by the autonomous mobile robot, a position of the robot; and
in response to a determination that the robot's location comprises the optimal location, then process the request.

14. The robot of claim 13, wherein the optimal location comprises a location at which the one or more images of the display screen meet one or more criteria for one or more visual parameters of a view of the display screen.

15. The robot of claim 14, wherein the one or more visual parameters comprise one or more of (1) a reflection from the display screen (2) an occlusion of the display screen and (3) an angle at which the camera captures an image relative to the display screen.

16. The robot of claim 13, wherein processing the request comprises:
capturing an image of content currently displayed on the display screen; and
determining, based on the user request and the captured image, a task execution plan for fulfilling the user request.

17. The robot of claim 16, wherein determining the task execution plan comprises:
determining, by a VLM of the robot, a graph structure representing a set of display-screen UI states; and
determining a navigation of the graph structure from an initial state corresponding to the captured image to a final state corresponding to fulfilling the user request.

18. The system of claim 17, wherein each state in the graph corresponds to a particular user interface of an application executing on the electronic device.

19. The system of claim 17, wherein the one or more processors are further operable to execute the instructions to, for each state in the navigation of the graph structure:
capture, by the camera of the robot, an image of the display screen,
determine, by a VLM of the robot, a particular sequence of remote operations to move from the current state to the next state in the navigation.

20. The system of claim 13, wherein the electronic device comprises a television.
